(19) United States
(12) Patent Application Publication
(10) Pub. No.: US 2003/0174494 A1
(43) Pub. Date: Sep. 18, 2003

(54) Illuminated device containing spinning electroluminescent wire

(76) Inventor: Mark Chernick, Woodinville, WA (US)

Correspondence Address: LAMORTE & ASSOCIATES P.C., P.O. BOX 434, YARDLEY, PA, 19067, US

(21) Appl. No.: 10/395,935

(22) Filed: Mar. 25, 2003

Related U.S. Application Data
(63) Continuation-in-part of application No. 10/188,821, filed on Jul. 5, 2002.
(60) Provisional application No. 60/364,468, filed on Mar. 14, 2002.

(51) Int. Cl. F21V 9/16; F21V 21/30

(52) U.S. Cl. 362/84; 362/287; 362/35

(57) ABSTRACT

A novelty item that spins at least one length of electroluminescent wire to produce a circular pattern of light. The device has at least one length of electroluminescent wire that radially extends from a rotating hub. Each length of electroluminescent wire may hang free or may be supported by a flexible arm that also extends from the rotating hub. When the hub rotates, the various lengths of electroluminescent light rotate about the hub in a circular pathway. This produces what appears to be an illuminated spinning disk of light.

### RELATED APPLICATIONS

This application claims priority of Provisional Patent Application No. 60/364,468, entitled Illuminated Device Containing Spinning Electroluminescent Wire, filed Mar. 14, 2002. This application is also a continuation-in-part of U.S. patent application Ser. No. 10/188,821, entitled Spinning Illuminated Novelty Device With Synchronized Light Sources, which was filed Jul. 5, 2002.

### BACKGROUND OF THE INVENTION

1. Field of the Invention

The present invention relates to illuminated novelty devices that spin and are used to produce observable patterns of light during low light conditions. More particularly, the present invention relates to such novelty devices where illuminated arms spin about a central hub.

2. Prior Art Statement

In the prior art, there are many different types of illuminated novelty devices that produce an observable pattern of light. Such devices are not used for the purposes of illumination, like a flashlight. Rather, such novelty devices are merely used to produce an interesting pattern of light that can be observed during low light conditions. Such novelty devices are commonly sold or distributed at events that are frequented by children and where there are low light conditions. Examples of such events include children's concerts, the circus, amusement parks at night, fireworks displays and the like.

There is a great variety in the types of illuminated novelty devices that exist. Some illuminated novelty devices use chemical luminescent light sources, where the observed light is created from a chemical reaction. Such chemical luminescent devices, however, cannot be selectively turned on and off once the chemical reaction has started. Furthermore, after a few hours, the chemical reaction ends and the novelty device is incapable of producing light. Furthermore, most chemical compositions used to produce light are toxic. Accordingly, the use of chemical luminescent novelty devices is inappropriate for many young children who may bite or teethe on the device.

Other types of illuminated novelty devices use batteries to provide power to either incandescent bulbs or light emitting diodes (LEDs). Often, to increase the interest of the pattern of light produced by the device, motors are used to move the electric light sources when they are illuminated. One popular type of illuminated novelty device is a device where multiple electric light sources are positioned on the tips of narrow flexible arms. The flexible arms are attached to a hub that is supported by a handle. In the handle is a motor that spins the hub when activated. As such, when a user activates the motor, the hub spins and the lights at the ends of the arms illuminate. The result is a circular pattern of light that is interesting to observe especially in low light conditions.

A problem associated with spinning electric novelty devices is that when LEDs are used, the LEDs only create a point of light. When the LED is positioned on a rotating arm, the spinning LED creates a narrow circle of light. If multiple LEDs are used on spinning arms, the LEDs create concentric circles of light. As such, the spinning arms are not completely or evenly illuminated by the LEDs.

A need therefore exists for a spinning novelty light that produces an even illumination along the length of spinning arm. In this manner, an evenly illuminated disk of light is created by the spinning arms. This need is met by the present invention as described and claimed below.

### SUMMARY OF THE INVENTION

The present invention is a novelty item that spins at least one length of electroluminescent wire to produce a circular pattern of light. The device has at least one length of electroluminescent wire that radially extends from a rotating hub. Each length of electroluminescent wire may hang free or may be supported by a flexible arm that also extends from the rotating hub. When the hub rotates, the various lengths of electroluminescent light rotate about the hub in a circular pathway. This produces what appears to be an illuminated spinning disk of light.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a perspective view of one exemplary embodiment of the invention;

FIG. 2 is a selectively cross-sectioned view of the embodiment shown in FIG. 1;

FIG. 3 is an alternate embodiment of the arm element of the invention;

FIG. 4 is another alternate embodiment of the arm element of the invention; and

FIG. 5 is a schematic of the electronic features of an alternate embodiment of the present invention.

### DESCRIPTION OF THE INVENTION

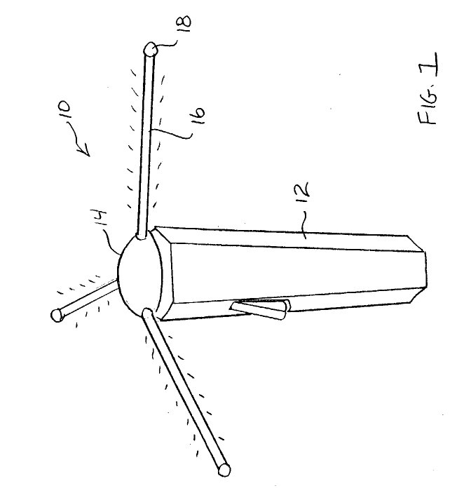

Referring to FIG. 1, an exemplary embodiment of the present invention device 10 is show. The device 10 contains a handle 12. The handle 12 supports a hub 14. Arms 16 radially extend from the hub 14. In the shown embodiment, three arms 16 extend from the hub 14. However, it should be understood that such a number is arbitrary and any number of arms 16 can be made to radially extend from the hub 14.

The arms 14 are comprised in whole, or in part, of electroluminescent wire. Electroluminescent wire is sometimes referred to as EL wire in the field of electronic illumination. When the electroluminescent wire is powered with a small current of electricity, the electroluminescent wire emits light along its length. The color of the light emitted depends upon the internal composition of the electroluminescent wire. The most common types of electroluminescent wire that are commercially available emit green, blue or yellow light. The structure of one type of appropriate electroluminescent wire is found in U.S. Pat. No. 5,869,930 to Baumberg, entitled Electroluminescent Light source with A Mixture Layer Filled with A Transparent Filler Substance, the disclosure of which is incorporated into this specification by reference.

Safety terminations 18 are coupled to the ends of the arms 16. The safety terminations 18 are enlarged objects and/or soft objects that would not cause harm if inadvertently brought into contact with the eyes or face. The safety terminations 18 can be either transparent or opaque. If transparent, light from the electroluminescent wire can be used to internally light the safety terminations 18.

The hub 14 rotates relative the handle 12. Accordingly, as the hub 14 rotates, the arms 16 extending from the hub 14 also rotate. As the hub 14 and arms 16 spin, current is directed to the electroluminescent wires in the arms 16. Consequently, the arms 16 illuminate along their length as they spin, thereby creating a spinning disk of light where the radius of the spinning disk outside the hub 14 is equal to the length of electroluminescent wire used.

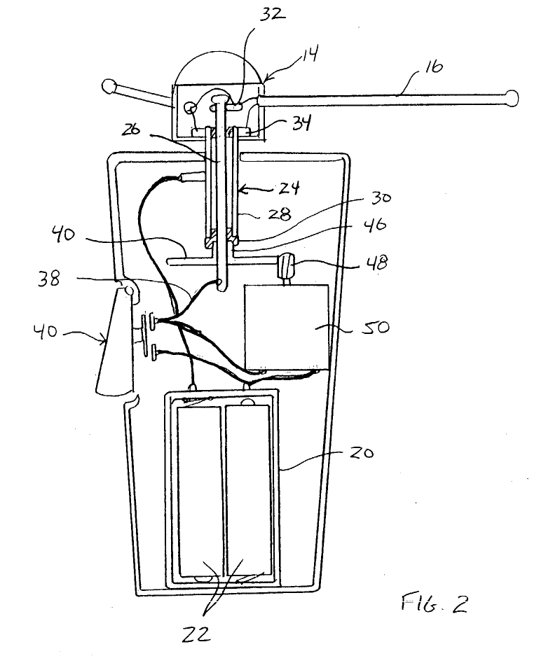

Referring To FIG. 2, it can be seen that in the housing 12, there is a port 20 for holding batteries 22. The power from the batteries 22 is used to both illuminate the electroluminescent wires on the arms 16 and rotate the hub 14.

The hub 14 is connected to a shaft assembly 24 that extends upwardly from the housing 12. The shaft assembly 24 contains a conductive inner shaft 26 and a conductive outer shaft 28. The inner shaft 26 and the outer shaft 28 are insulated from each other using spacers 30 that are disposed in between the inner shaft 26 and the outer shaft 28. The spacers 30 also act as bearings between the inner shaft 26 and the outer shaft 28. As such, the outer shaft 28 is free to rotate independently of the inner shaft 26.

In the hub 14, there is located a first connector 32 that spins around the inner shaft 26 and makes electrical contact with the inner shaft 26. In the hub 14 is also located a second connector 34. The second connector 34 is coupled to both the structure of the hub 14 and the outer shaft 28. Two leads extend from each electroluminescent wire used in the arms 16. One lead from every electroluminescent wire is coupled to the inner shaft 26, via the first connector 31. Similarly, the second wire from each electroluminescent wire is coupled to the outer shaft 28, via the second connector 34.

The inner shaft 26 is coupled to the battery port 20 utilizing a wire pathway 38. The wire pathway 38 is disrupted by an on/off switch 40 that can be manually activated by a person holding the housing 12. Accordingly, a person holding the housing 12 can selectively control the on/off switch 40 and therefore can control the flow of electrical power to the inner shaft 26.

The opposite terminal of the battery port 20 is coupled to a wiping contact 42. The wiping contact 42 presses against the outer shaft 28 of the shaft assembly 24. Accordingly, when the on/off switch 40 is manually closed a circuit is completed. The circuit starts at one terminal of the battery port 20 and then travels through the inner shaft 26 up to the electroluminescent wires. The circuit then returns to the opposite battery port terminal from the electroluminescent wires through the outer shaft 28, via the wiping contact 42. It should therefore be understood that each time the on/off switch 40 is pressed closed, the electroluminescent wires will illuminate.

A drive gear 44 is disposed around the inner shaft 26. However, the drive gear 44 is not attached to the inner shaft 26 and spins freely about the inner shaft 26. The drive gear 44 has a protrusion 46 that engages the spacer 30 between the inner shaft 26 and the outer shaft 28. Accordingly, when the drive gear 44 spins, the drive gear 44 turns the spacer 30, thereby turning the outer shaft 28. The outer shaft 28 is connected to the hub 14. Consequently, when the outer shaft 28 spins, the hub 14 spins. However, the connection between the gear hub 14 and the spacer 30 is only a fiction connection. Accordingly, should the hub 14 be prevented from spinning by contact with a foreign object, the drive gear 44 will still spin independently of the spacer 30. This friction interconnection acts as a clutch and prevents the drive gear 44 from becoming damaged should the spinning hub 14 ever suddenly strike an object and stop spinning.

The drive gear 44 is turned by a pinion gear 48. The pinion gear 48 is directly turned by the electric motor 50. Accordingly, when the electric motor 50 is activated, the motor 50 turns the pinion gear 48, that turns the drive gear 44, that turns the outer shaft 28, that turns the hub 14, that turns the arms 16.

The wire pathway that connects the electric motor 50 to the battery port 20 also passes through the on/off switch 40. Consequently, when the on/off switch 40 is pressed, power is supplied to the electroluminescent wires that extend from the hub 14 and power is supplied to the motor 50 that turns the hub 14.

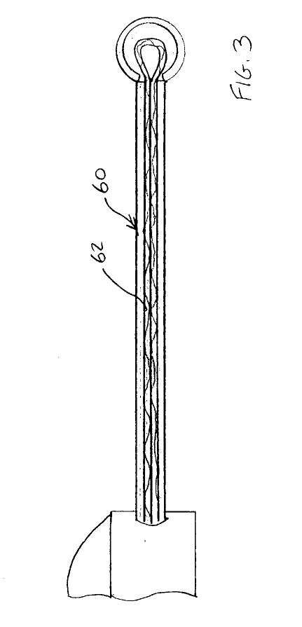

In the embodiment of FIG. 1 and FIG. 2, the arms 16 that extend from the hub 14 are made from electroluminescent wire. Referring now to FIG. 3, it can be seen that the arms that extend from the hub can contain structural elements other than electroluminescent wire. In FIG. 3, a translucent flexible arm element 60 is provided. Electroluminescent wire 62 is disposed within the flexible arm 60. Accordingly, when the electroluminescent wire 62 is powered, the electroluminescent wire 62 internally illuminates the flexible arm element 60.

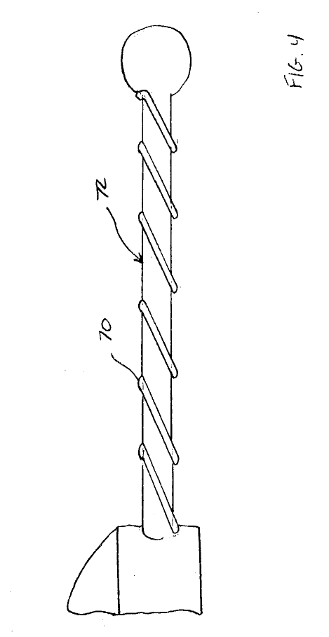

Referring to FIG. 4, electroluminescent wire 70 is wrapped around the exterior of a flexible arm element 72 in a helical pattern. When the electroluminescent wire 70 is powered, the helical pattern of the electroluminescent wire 70 becomes highly visible on the flexible arm element 72, thereby creating an aesthetically pleasing rotating display.

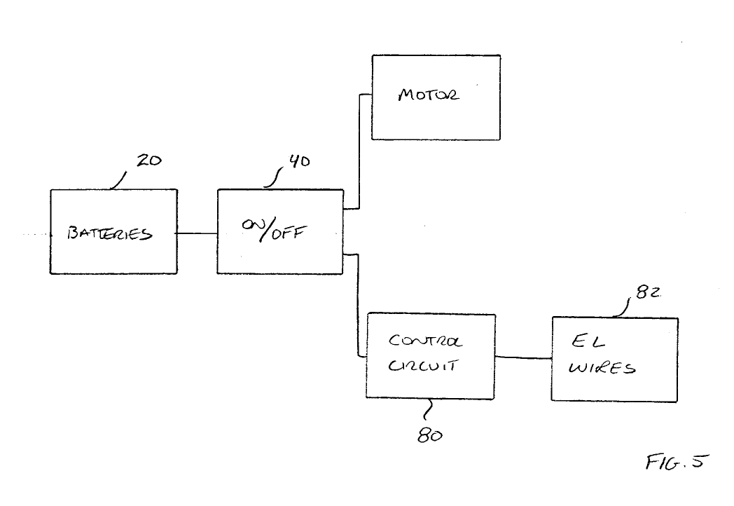

In the embodiment of the present invention previously described, the electroluminescent wire is illuminated when the on/off switch is pressed and remains illuminated until the on/off switch is released. This mode of operation is merely exemplary and it should be understood that modes of operation that flash the electroluminescent wires can be used. Such an embodiment is shown in FIG. 5. Referring to FIG. 5, an embodiment of the present invention is shown where the control circuit 80 is placed between the on/off switch 40 and the electroluminescent wires 82. The control circuit 80 can light the various electroluminescent wires 82 in any flash pattern or sequence. Accordingly, different electroluminescent wires 82 can be illuminated at different times. This will enable the electroluminescent wires 82 to produce more interesting light patterns as they spin around.

It will be understood that the embodiments of the present invention specifically described and illustrated are merely exemplary and the shown embodiments can be modified in many ways. For example, the number of arms and the position of the arms can be varied in any manner by a person skilled in the art. Furthermore, the shape of the arms, the hub and the handle can be varied. All such alternate embodiments and variations are intended to be included within the scope of the claims as listed below.

What is claimed is:

1. An illuminated assembly, comprising:
a hub;
a motor for rotating said hub;
a plurality of flexible arms extending from said hub;
at least one length of electroluminescent wire supported by at least one of said plurality of arms, wherein said length of electroluminescent wire illuminates as said hub and said flexible arms spin.

2. The assembly according to claim 1, further including a control circuit for selectively flashing said length of electroluminescent wire.

3. The assembly according to claim 2, wherein said control circuit rotates with said hub.

4. The assembly according to claim 1, wherein said length of electroluminescent wire is disposed within at least one of said flexible arms and internally illuminates at least one of said flexible arms.

5. The assembly according to claim 1, wherein said length of electroluminescent wire is wrapped around at least one of said flexible arms.

6. The assembly according to claim 1, further including a handle element for supporting said hub, wherein said motor is disposed within said handle.

7. The assembly according to claim 1, having multiple lengths of electroluminescent wire, wherein each length of electroluminescent wire produces light of a different color.

8. An illuminated assembly, comprising:
a hub;
a mechanism for rotating said hub;
at least one length of electroluminescent wire extending from said hub, wherein said length of electroluminescent wire illuminates as said hub spins.

9. The assembly according to claim 8, further including a plurality of arms extending from said hub, wherein said arms support said at least one length of electroluminescent wire.

10. The assembly according to claim 8, further including a control circuit for selectively flashing said length of electroluminescent wire.

11. The assembly according to claim 10, wherein said control circuit rotates with said hub.

12. The assembly according to claim 9, wherein said length of electroluminescent wire is disposed within at least one of said flexible arms and internally illuminates at least one of said flexible arms.

13. The assembly according to claim 9, wherein said length of electroluminescent wire is wrapped around at least one of said flexible arms.

14. The assembly according to claim 8, further including a handle element for supporting said hub, wherein said mechanism is disposed within said handle.

15. The assembly according to claim 8, having multiple lengths of electroluminescent wire, wherein each length of electroluminescent wire produces light of a different color.

16. A method of manufacturing a spinning light assembly, comprising the steps of:
providing a set of arms that radially extend from a central hub, wherein each of said arms is flexible;
attaching a length of electroluminescent wire to each of said arms;
rotating said arms at a predetermined speed;
providing power to each length of electroluminescent wires as it rotates with said arms, wherein said electroluminescent wires illuminate.

17. The method according to claim 16, wherein said step of attaching an length of electroluminescent wire to each of said arms includes placing a length of electroluminescent wire into each of said arms, thereby internally illuminating each of said arms.

18. The method according to claim 16, wherein said step of attaching a length of electroluminescent wire to each of said arms includes wrapping a length of electroluminescent wire around each of said arms.
